(19) United States
(12) Patent Application Publication
(10) Pub. No.: US 2015/0181322 A1
(43) Pub. Date: Jun. 25, 2015

(54) EARPHONE DEVICE

(71) Applicant: Chiun Mai Communication Systems, Inc., New Taipei (TW)

(72) Inventor: PO-SEN HUANG, New Taipei (TW)

(21) Appl. No.: 14/570,041

(22) Filed: Dec. 15, 2014

(30) Foreign Application Priority Data
Dec. 19, 2013 (CN) 201310698903.7

(51) Int. Cl. H04R 1/10

(52) U.S. Cl. CPC H04R 1/10

(57) ABSTRACT

An earphone device includes a housing, a speaker diaphragm and a tuner. The housing has an exterior surface and defines an interior cavity. The speaker diaphragm is positioned within the interior cavity and divides the interior cavity into a first chamber and a second chamber. The housing further includes a plurality of openings defined to connect the first chamber to the exterior of the housing, and a plurality of vents defined to connect the second chamber to the exterior surface. The speaker diaphragm is configured to selectively produce sound and sound produced by the speaker diaphragm is acoustically transferred from the first chamber through the openings and away from the housing. The tuner is configured to selectively open and close one or more of the plurality of vents.

### FIELD

The subject matter herein generally relates to earphone devices, and particularly to an acoustic tunable earphone device.

### BACKGROUND

Earphones are commonly used with a variety of electronic devices to provide mobile and/or personal access to audio content. For example, earphones can be used with music players, such as MP3, and CD players. Earphones can also be used with cellular phones, personal digital assistants, computers, and most other types of electronic devices that produce audio signals. However, the acoustic performance of the conventional earphones at different frequency, such as, low frequency, middle frequency, and high frequency are not tunable.

### BRIEF DESCRIPTION OF THE DRAWINGS

Implementations of the present technology will now be described, by way of example only, with reference to the attached figures.

FIG. 1 is an isometric view of one embodiment of an earphone device.

FIG. 2 is similar to FIG. 1, but showing the earphone device from another angle.

FIG. 3 is a cross sectional view of the earphone device as shown in FIG. 2 along line III-III.

FIG. 4 is similar to FIG. 3, but showing a tuner of the earphone device in another position.

FIG. 5 is an exploded, isometric view of the earphone device as shown in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “comprising” when utilized, means “including, but not necessarily limited to”; it specifically indicates open-ended inclusion or membership in the so-described combination, group, series and the like.

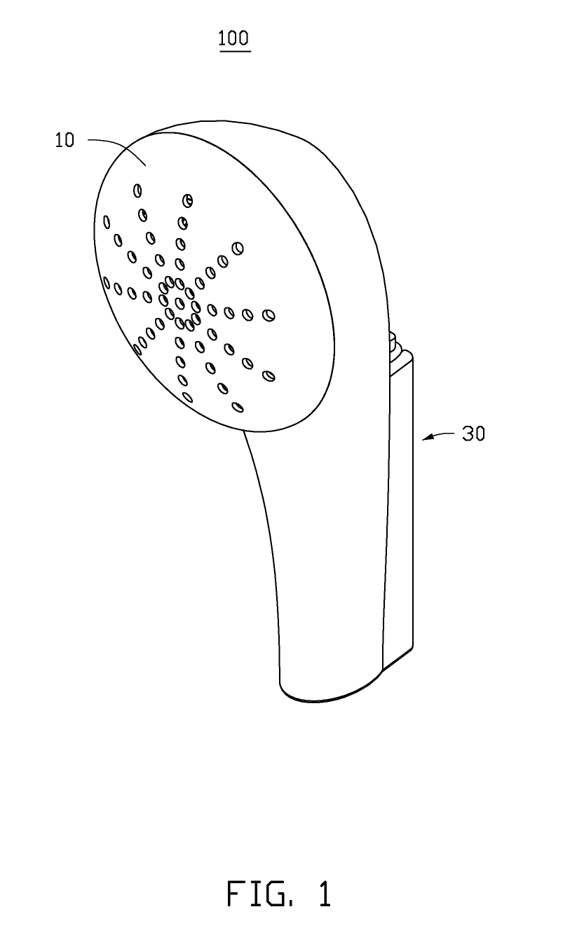

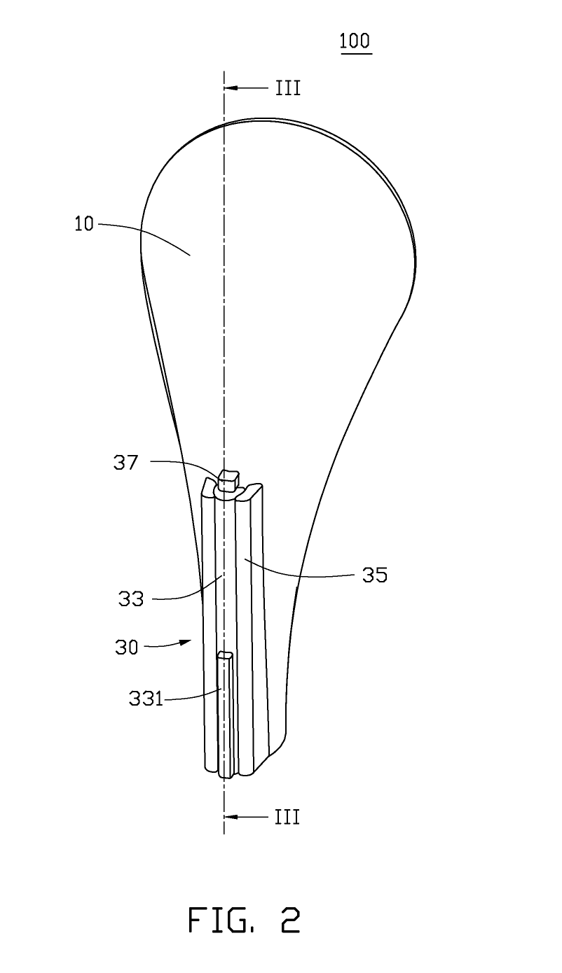

FIGS. 1-2 illustrate isometric views of one embodiment of an earphone device 100 from two angles respectively. The earphone device 100 can include a housing 10 and an acoustic tuning structure 30 disposed to the housing 10.

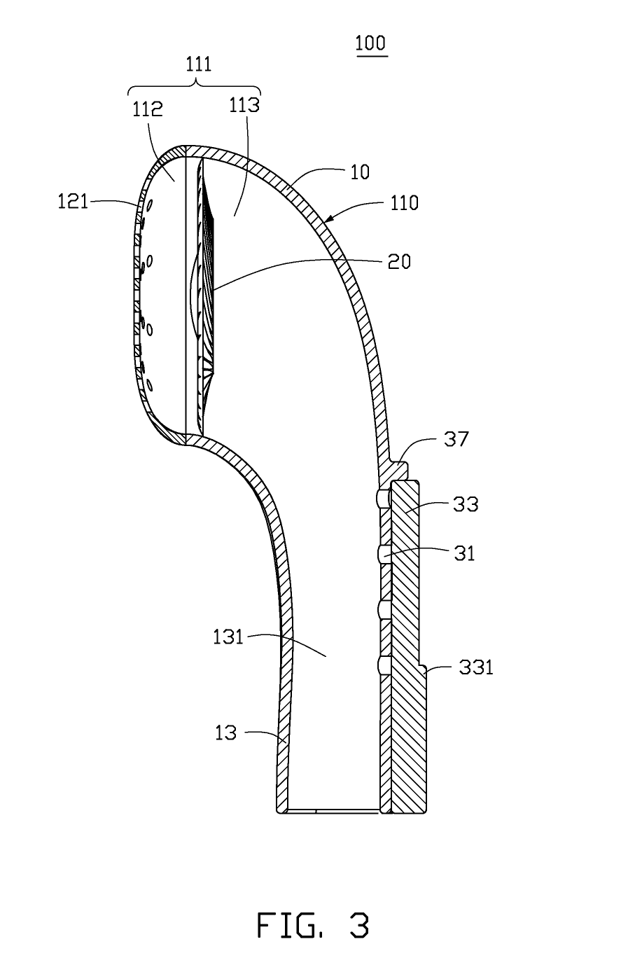

FIG. 3 illustrates a cross sectional view of the earphone device 100 as shown in FIG. 2 along line III-III. The housing 10 can have an exterior surface 110, and define a cavity 111, and a plurality of openings 121. The earphone device 100 further includes a speaker diaphragm 20 received into the cavity 111 and dividing the cavity 111 into a first chamber 112 and a second chamber 113. The speaker diaphragm 20 is configured to produce sound. The first chamber 112 is acoustically coupled to the openings 121 that are configured to transfer the sound to the exterior of the housing 10. The acoustic tuning structure 30 includes a plurality of vents 31 and a tuner 33. The plurality of vents 31 are defined through the housing 10 and acoustically coupled to the second chamber 113. The tuner 30 is configured to selectively open and close one or more of the plurality of vents 31. As shown in FIG. 3, all vents 31 are closed relative to the atmosphere by the tuner 30.

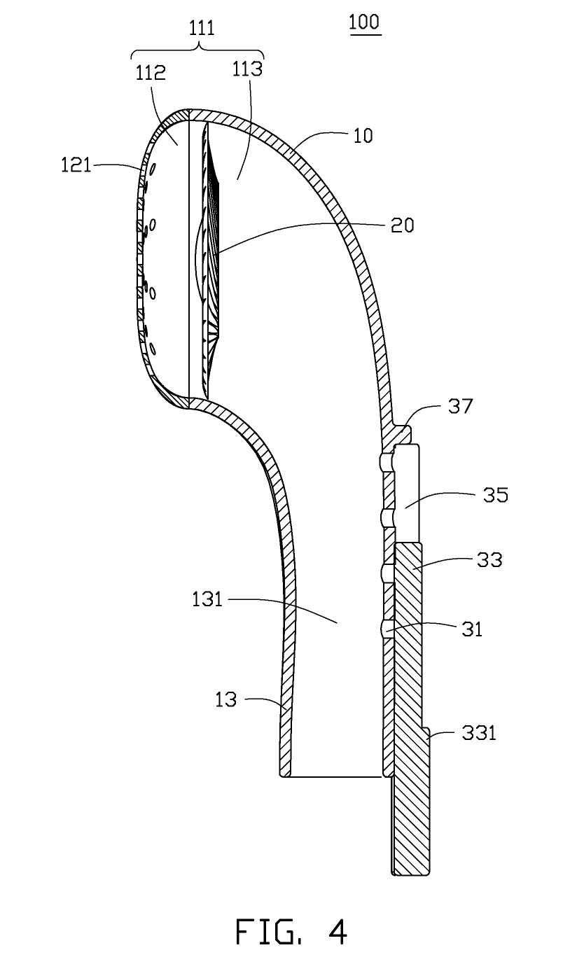

FIG. 4 is similar to FIG. 3, but showing the tuner 33 of the earphone device 100 in another position. The tuner 30 can slide relative to the housing 10 to select a combination of the vents 31. That is, a number of the vents 31 can be opened/closed relative to the atmosphere by sliding the tuner 30. As shown in FIG. 4, two of the vents 31 are opened to the atmosphere with others being closed by the tuner 33.

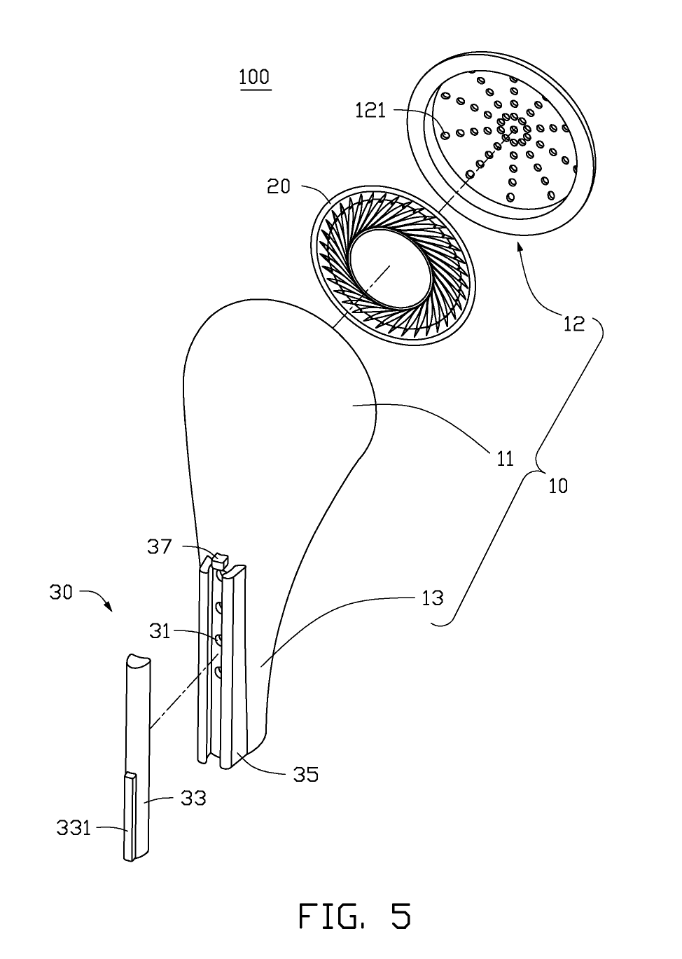

FIG. 5 illustrates an exploded, isometric view of the earphone device as shown in FIG. 2. The housing 10 can include a main body 11, a cover 12 fastened to the main body 11, and a tube portion 13 extending from the main body 11. The main body 11 can be hemispherical, the cavity 111 is defined inside the main body 11. The plurality of openings 121 is defined through the cover 12. A duct 131 (see FIG. 3) is defined inside the tube portion 13 and acoustically coupled to the second chamber 113 and the plurality of vents 31.

The acoustic tuning structure 30 further includes two rails 35 and a limiting block 37. The two rails 35 are mounted onto the housing 11 and are parallel to each other. In at least one embodiment, the two rails 35 are mounted onto the tube portion 13. The plurality of vents 31 are positioned between the two rails 35 and are arranged into a line. The tuner 33 is a rod and is slidably engaged between the two rails 35. By the slide of the tuner 33, the tuner 33 can selectively open and close one or more of the plurality of vents 31. The limiting block 37 is located between the two rails 35 and adjacent to an end of each rail 35. The limiting block 37 (also see FIGS. 1-4) is configured to resist against the tuner 33 to prevent the tuner 33 from escaping from the two rails 35. The tuner 33 has an operation portion 331 protruding from a surface of the tuner 33 opposite to the tube portion 13. The operation portion 331 is configured to facilitate an operation of the tuner 33.

In use, modulated electrical current (produced by an amplifier) passes through a “speaker coil” of the speaker diaphragm which then (through inductance) magnetizes the coil, creating a magnetic field. The electrical current variations that pass through the coil are thus converted to varying magnetic forces, which move the speaker diaphragm to produce air motion that is similar to the original signal from the amplifier, thus sound is produced. In addition, the second chamber 113 can satisfy the principle of the Helmholtz resonator that can change the frequency characteristic of the sound produced by the speaker diaphragm 20. As can be seen from FIGS. 3-4, a number of the vents 31 can be opened/closed by sliding the tuner 33. Accordingly, a resonant frequency of the second chamber 113 can be regulated, and thus the frequency characteristic and an acoustic performance of the sound produced by the speaker diaphragm 20 can be regulated. In addition, since the frequency characteristic can be changed using mechanical elements, the acoustic performance of the earphone device 100 can be adjusted simply and efficiently.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An earphone comprising:
a housing having an exterior surface and defining an interior cavity;
a speaker diaphragm positioned within the interior cavity and dividing the interior cavity into a first chamber and a second chamber; and
a tuner;
wherein, the housing includes a plurality of openings defined to connect the first chamber to the exterior of the housing;
wherein, the speaker diaphragm is configured to selectively produce sound and sound produced by the speaker diaphragm is acoustically transferred from the first chamber through the openings and away from the housing;
wherein, the housing includes a plurality of vents defined to connect the second chamber to the exterior surface; and
wherein, the tuner is configured to selectively open and close one or more of the plurality of vents.

2. The earphone device of claim 1, further comprising two parallel rails mounted to the housing, wherein the plurality of vents are arranged into a line and are positioned between the two rails; the tuner is slidably engaged between the two rails to open and close one or more of the plurality of vents.

3. The earphone device of claim 2, further comprising a limiting block located between the two rails and adjacent to an end of each of the two rails, wherein the limiting block is configured to resist against the tuner to prevent the tuner from escaping from the two rails.

4. The earphone device of claim 2, wherein the tuner has an operation portion protruding from a surface of the tuner opposite to the housing; the operation portion is configured to facilitate an operation to the tuner.

5. The earphone device of claim 2, wherein the housing comprises a main body, a cover fastened to the main body, and a tube portion extending from the main body; the cavity is defined inside the main body, the plurality of openings are defined through the cover; the two rails are mounted to the tube portion.

6. The earphone device of claim 5, wherein the housing further comprises a duct defined in the tube portion and acoustically coupled to the second chamber, the plurality of vents are acoustically coupled to the duct.

7. An earphone device comprising:
a housing having an exterior surface, and defining an interior cavity and a plurality of openings;
a speaker diaphragm received into the cavity and dividing the cavity into a first chamber and a second chamber; the speaker diaphragm configured to selectively produce sound; the first chamber acoustically coupled to the openings that are configured to transfer the sound produced by the speaker diaphragm to outside of the housing; and
an acoustic tuning structure comprising a plurality of vents and a tuner, the plurality of vents defined to connect the second chamber to the exterior surface; the tuner configured to selectively open and close one or more of the plurality of vents.

8. The earphone device of claim 7, wherein the acoustic tuning structure further comprises two parallel rails mounted to the housing, the plurality of vents are arranged into a line and are positioned between the two rails; the tuner is slidably engaged between the two rails to open and close one or more of the plurality of vents.

9. The earphone device of claim 8, wherein the acoustic tuning structure further comprises a limiting block located between the two rails and adjacent to an end of each of the two rails, the limiting clock is configured to resist against the tuner to prevent the tuner from escaping from the two rails.

10. The earphone device of claim 8, wherein the tuner has an operation portion protruding from a surface of the tuner opposite to the housing; the operation portion is configured to facilitate an operation to the tuner.

11. The earphone device of claim 8, wherein the housing comprises a main body, a cover fastened to the main body, and a tube portion extending from the main body; the cavity is defined inside the main body, the plurality of openings are defined through the cover; the two rails are mounted to the tube portion.

12. The earphone device of claim 11, wherein the housing further comprises a duct defined in the tube portion and acoustically coupled to the second chamber, the plurality of vents are acoustically coupled to the duct.

13. An earphone device comprising:
a housing defining a cavity, and a plurality of openings;
a speaker diaphragm received into the cavity and dividing the cavity into a first chamber and a second chamber; the speaker diaphragm configured to produce sound; the first chamber acoustically coupled to the openings that are configured to transfer the sound to outside of the housing; and
an acoustic tuning structure comprising a plurality of vents and a tuner, the plurality of vents defined through the housing and acoustically coupled to the second chamber; the tuner is movable between at least first and second positions with respect to the housing to open and close one or more of the plurality of vents.

14. The earphone device of claim 13, wherein the acoustic tuning structure further comprises two parallel rails mounted to the housing, the plurality of vents are arranged into a line and are positioned between the two rails; the tuner is slidably engaged between the two rails to open and close one or more of the plurality of vents.

15. The earphone device of claim 14, wherein the acoustic tuning structure further comprises a limiting block located between the two rails and adjacent to an end of each of the two rails, the limiting clock is configured to resist against the tuner to prevent the tuner from escaping from the two rails.

16. The earphone device of claim 14, wherein the tuner has an operation portion protruding from a surface of the tuner opposite to the housing; the operation portion is configured to facilitate an operation to the tuner.

17. The earphone device of claim 14, wherein the housing comprises a main body, a cover fastened to the main body, and a tube portion extending from the main body; the cavity is defined inside the main body, the plurality of openings are defined through the cover; the two rails are mounted to the tube portion.

18. The earphone device of claim 17, wherein the housing further comprises a duct defined in the tube portion and acoustically coupled to the second chamber, the plurality of vents are acoustically coupled to the duct.
